(19) United States
(12) Patent Application Publication
(10) Pub. No.: US 2007/0060694 A1
(43) Pub. Date: Mar. 15, 2007

(54) Plasticer and polymer composition

(76) Inventor: Osamu Ogata, Tokyo (JP)

Correspondence Address: LADAS & PARRY LLP, 224 SOUTH MICHIGAN AVENUE, SUITE 1600, CHICAGO, IL, 60604, US

(21) Appl. No.: 10/575,451

(22) PCT Filed: Sep. 13, 2004
(86) PCT No.: PCT/JP04/13332

§ 371 Date: Apr. 12, 2006

(30) Foreign Application Priority Data
Oct. 16, 2003 (JP) 2003-356546

(51) Int. Cl. C08K 5/01

(52) U.S. Cl. 524/474

(57) ABSTRACT

A plasticizer that exhibits desirable plasticizer performance and excels in safety and economical efficiency; and a polymer composition utilizing the same. The plasticizer characterized in that it contains 20 to 100% by mass of a high degree hydrocracking process residue, and has a softening point of 30° C. or higher and a kinematic viscosity of 3000 mm²/s or less at 100° C.

### TECHNICAL FIELD

The present invention relates to a plasticizer, a polymer composition to which the same is added, and a tire.

### BACKGROUND ART

In the processing of rubber or other polymers, necessary is a component for improving flexibilities, such as extensibility and fluidity, which are necessary for a processing such as molding or extrusion, or dispersing various additives homogeneously. The name of this component is varied by the industries or steps. For example, it is called a process oil, an extender, a plasticizer, a lubricant, an extender oil, a softener, a diluting agent or the like. In the present specification, any component added for improving the fluidity of a polymer under a high temperature condition in the step of processing the polymer or disperse various compounding agents homogeneously, examples of the component including the above-mentioned oils and agents, are generically called a plasticizer.

Hitherto, plasticizers are required to have plasticizing effect; therefore, liquid plasticizers having a low viscosity have been used. In recent years, however, the safety of these plasticizers has been becoming a problematic issue.

For example, a polymer used as a container for pot noodle or school meals, or as some other product is added with a plasticizer. When the container or the like is used, the plasticizer elutes on the surface little by little so as to produce a bad effect on the human body. This is becoming a social problem.

About a plasticizer (such as process oil) used in rubber-processed products such as a tire, safety thereof is being assessed inside and outside the country. The plasticizers currently used for rubber products are mainly solvent extracted oils (aromatic lubricants). These are liquids having a low viscosity, and are plasticizers which have good performances, do not damage physical properties of products, and are also excellent in costs. However, contamination based on elution of the plasticizers, and polycyclic aromatic organic harmful substances (hereinafter referred to as PCAs) are becoming problems.

Against this, Patent Document 1 discloses a method for hydrogenating PCAs selectively from a solvent extracted oil. However, in order to purify the extracted oil into a target composition by the hydrogenation, it is necessary that the content of the PCAs in the solvent extracted oil before the hydrogenation is not less than a given level. Thus, after all, it is necessary to conduct minute purification before the hydrogenation. Consequently, the method is not a fundamental solution.

Patent Document 2 discloses a method of re-extracting a solvent extracted oil with DMSO (dimethylsulfoxide) to remove harmful substances. It is reported that even in a solvent extracted oil containing PCAs in a relatively large amount of more than twenty percent, this method makes it possible to remove the PCAs up to an amount of about 3% or less. However, the steps based on the re-extraction increase, and the loss of the solvent extracted oil itself is large. Thus, this method is not practical from the viewpoint of costs.

In all the purifying methods, the production efficiency thereof is low. Thus, the methods cannot cope with a great deal of demand in the industry. Furthermore, about solvent extracted oils based on these purifying methods, their performances as plasticizers is also lowered, so that physical properties themselves of polymer-processed products to which the oils are added, such as rubber products, are deteriorated. Additionally, the compatibility thereof based on the purification is lowered, whereby the solvent extracted oils easily bleed on the polymer surface in a larger amount than unpurified solvent extracted oils. After all, contamination problems based on the elution of the PCAs are not solved even if the content of PCAs in the solvent extracted oils is decreased.

Patent Document 1: Japanese Patent Application Laid-Open (JP-A) No. 11-80755

Patent Document 2: JP-A No. 2000-63849

### DISCLOSURE OF THE INVENTION

### Problems to be Solved by the Invention

Thus, an object of the present invention is to provide a plasticizer, which is good in plasticizer performances and is excellent in safety and economical efficiency, and a polymer composition in which the same, is used.

### MEANS FOR SOLVING THE PROBLEMS

A primary cause that a plasticizer causes a harmful effect on the environment or the human body is that the softening point of the plasticizer itself is low. When the plasticizer is used or left undisposed as it is or is scattered in the air as tire-worn powder, the plasticizer, which is in a liquid form, elutes easily from the polymer and the eluting plasticizer causes a harmful effect directly in the human body or the environment. For example, when the above-mentioned tire or other rubber products are left in an outdoor natural environment for a long term, a liquid solvent extracted oil or a solvent extracted oil having a very low viscosity is released, separated or eluted by heat or ultraviolet rays. Thus, harmful substances contained in the solvent extracted oil give damage directly to the human body, or contaminate soil or underground water veins.

The inventor has paid attention to an effect obtained by a substance that such a liquid plasticizer is made into a solid form in the temperature range of the living body or the temperature range of the use thereof. If a plasticizer is liquid in a producing/processing temperature range but is a solid in the living body temperature range or the use temperature range, the plasticizer does not have wettability to living bodies so that no penetration of harmful substances from the skin or any mucous membrane is caused. Specifically, a plasticizer into which a high degree hydrocracking process residue, which is a treated asphalt/bitumen product, is incorporated, and so on are used, thereby exhibiting a low viscosity, that is, a plasticizer effect in liquid form sufficiently under high temperature conditions at the processing stage of the polymer, and thereby becoming a solid in the living body temperature or the use temperature range so as to enable to prevent the elution of harmful substances. This has been found out and thus the present invention has been made.

Thus, the invention of claim 1 provides a plasticizer, comprising 20 to 100% by mass of a high degree hydrocracking process residue, and having a softening point of 30° C. or higher and a kinematic viscosity of 3000 mm²/s or less at 100° C., so as to solve the above-mentioned problems.

The “high degree hydrocracking process residue” means a residue obtained by hydrogenating the vacuum distillation residue of crude oil at the temperature of 350° C. or higher, a pressure of 12.0 MPa or more, and an atmosphere hydrogen concentration of 70 to 90% on a fluid catalyst bed and further removing 50% or more by mass of light contents therefrom at a temperature of 300° C. or higher and a pressure of 13.8 kPa or less.

The step of hydrogenating the vacuum distillation residue at a temperature of 350° C. or higher, a pressure of 12.0 MPa or more, and an atmosphere hydrogen concentration of 70 to 90% on a fluid catalyst bed is a step of hydrocracking the vacuum distillation residue of crude oil to a high degree. The step of removing 50% or more by mass of light contents at a temperature of 300° C. or higher and a pressure of 13.8 kPa or less is a step of separating an middle distillate generated by the decomposition of a part of the vacuum distillation residue and the residue from each other.

According to this invention, the plasticizer has a high degree hydrocracking process residue excellent in plasticizing effect; accordingly, the plasticizer can have excellent performances. Additionally, the plasticizer of the invention is in a solid state at ambient temperature. It is therefore possible to prevent release, separation, elution or the like of harmful substances in the plasticizer in a use or storage state. Thus, the plasticizer can be excellent in safety. Furthermore, only the high degree hydrocracking process residue, which is relatively inexpensive, is added thereto; therefore, no step is complicated, and costs of raw materials do not increase. Thus, the plasticizer can be excellent in economical efficiency.

The invention of claim 2 provides a plasticizer in which 20 to 400 parts by mass of a high degree hydrocracking process residue are added to 100 parts by mass of a mineral oil plasticizer, so as to solve the above-mentioned problems.

The “mineral oil plasticizer” means a mixture which has a function as a plasticizer of the invention, and is mainly made of hydrocarbons obtained by subjecting crude oil to normal pressure distillation, vacuum distillation, extraction or other treatments without undergoing any steps based on chemical reaction (except hydrogenating reaction). Further, the flashing point of the mineral oil plasticizer is 200° C. or higher.

According to this invention, the plasticizer comprises a mineral oil plasticizer excellent in plasticizing effect and a high degree hydrocracking process residue. Thus, the plasticizer can have excellent performances. Additionally, the plasticizer of the invention is in a solid state at ambient temperature. It is therefore possible to prevent release, separation, elution or the like of harmful substances in the plasticizer in a use or storage state. Thus, the plasticizer can be rendered a plasticizer excellent in safety. Furthermore, only the high degree hydrocracking process residue, which is relatively inexpensive, is added thereto; therefore, no step becomes complicated, and costs of raw materials do not increase. Thus, the plasticizer can be excellent in economical efficiency.

The invention of claim 3 is the plasticizer according to claim 2 in which the mineral oil plasticizer is a solvent extracted oil.

The “solvent extracted oil” means components which are rich in aromatic hydrocarbon and are extracted from light, middle and heavy oils fractionized in a vacuum distillation tower or a vacuum distillation residue oil with a solvent in a solvent extraction step, which is one out of steps of purifying mineral oil lubricant; and a mixture of two or more out of these extracted components.

According to this invention, the compatibility with polymer at high temperature can be improved. Thus, the plasticizer can have a better performance.

The invention of claim 4 provides a polymer composition to which the plasticizer according to any one of claims 1 to 3 is added, so as to solve the above-mentioned problems.

According to this invention, it is possible to provide a polymer composition excellent in workability, safety and economic efficiency.

The invention of claim 5 provides a rubber composition to which the plasticizer according to any one of claims 1 to 3 is added, so as to solve the above-mentioned problems.

According to this invention, it is possible to provide a rubber excellent in workability, safety and economic efficiency.

The invention of claim 6 provides a tire by which the rubber composition according to claim 5 is processed, so as to solve the above-mentioned problems.

According to this invention, it is possible to provide a tire excellent in workability, safety and economic efficiency.

### ADVANTAGEOUS EFFECTS OF THE INVENTION

The plasticizer of the invention exhibits performances equivalent to those of conventional plasticizers at high temperature at the time of processing, and additionally the plasticizer is in a solid form at temperature when the object is used as a product; therefore, harmful substances incorporated therein do not easily undergo release, separation, elution or the like. Thus, the plasticizer is excellent in safety. Since the plasticizer is produced only by incorporating the high degree hydrocracking process residue, which is relatively inexpensive, the plasticizer is excellent in productivity and economical efficiency.

Such effects and advantages of the invention will be made apparent from the best mode for carrying out the invention, which will be described in the following.

### BEST MODE FOR CARRYING OUT THE INVENTION

The plasticizer of the invention includes a high degree hydrocracking process residue. The high degree hydrocracking process residue means a residue obtained by hydrogenating the vacuum distillation residue of crude oil at a temperature of 350° C. or higher, a pressure of 12.0 MPa or more, and an atmosphere hydrogen concentration of 70 to 90% on a fluid catalyst bed and further removing 50% or more by mass of light contents therefrom at a temperature of 300° C. or higher and a pressure of 13.8 kPa or less. Accordingly, the high degree hydrocracking process residue is, in a sense, a substance obtained by hydrogenating asphalt under given conditions.

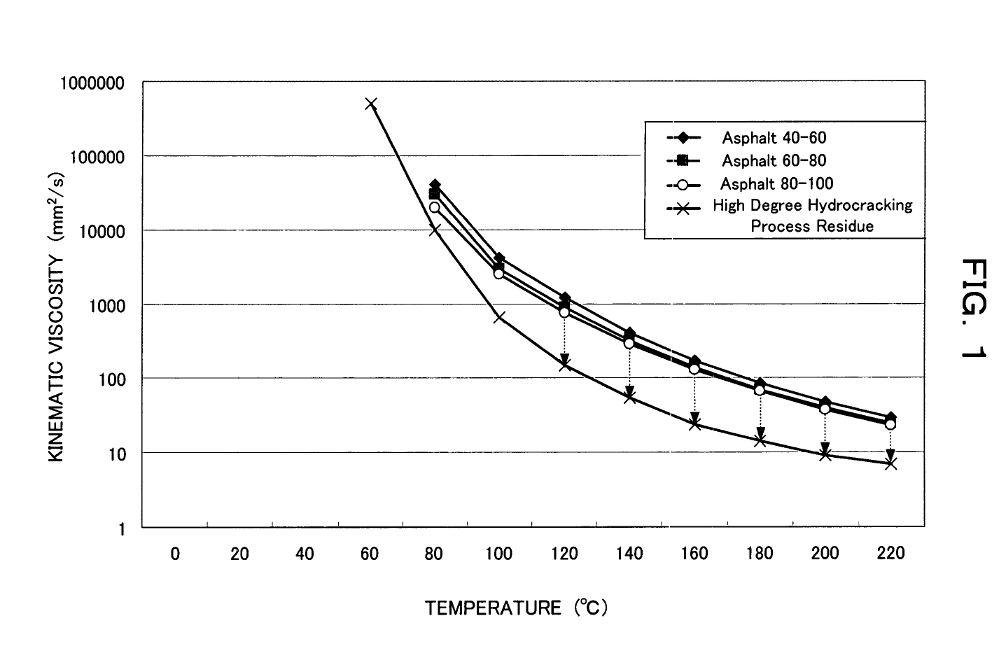

FIG. 1 is a graph showing relationship between kinematic viscosity and temperature about three ordinary straight asphalts different in penetration and high degree hydrocracking process residues therefrom. From this, it is understood that a large difference in viscosity between the two is not seen at temperatures of 80° C. or lower, but at high temperatures, the viscosity of the high degree hydrocracking process residues is lower than that of the asphalts. In other words, it is understood that the high degree hydrocracking process residues are better in compatibility with polymers at high temperatures than the asphalts, so as to be better in plasticity than the asphalts. Furthermore, the high degree hydrocracking process residues undergo a hydrogenating step; therefore, when the high degree hydrocracking process residues are used as plasticizers, the amount of polar materials, which easily undergo side reaction with the polymers, is small therein. Thus, the residues have, as a reflective effect thereto, an advantage that the content of sulfur therein is also low.

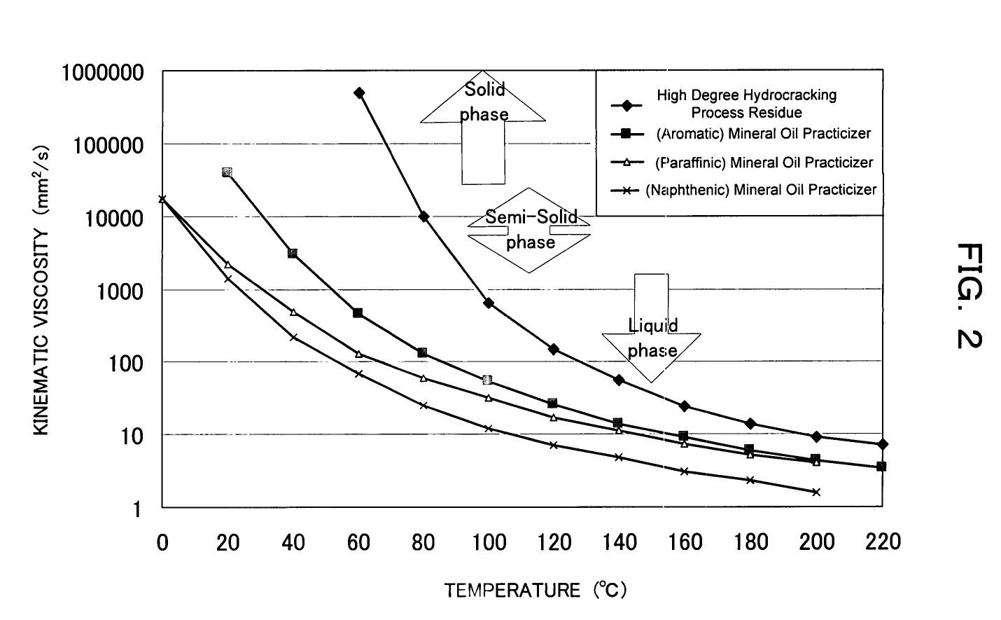

FIG. 2 is a graph showing relationship between kinematic viscosity and temperature about a high degree hydrocracking process residue and typical commercially available mineral oil plasticizers, which are generally used as plasticizers for rubber. In any one of the plasticizers, the viscosity rises as the temperature falls. In particular, about the high degree hydrocracking process residue, the rise is remarkable. Around 90° C., the residue turns into a semi-solid phase, and at temperatures around 70° C. the residue turns into a substantial solid form. On the other hand, about the mineral oil plasticizers, the viscosity thereof is still low even at around room temperature. Thus, it is understood that the plasticizers are in a liquid phase. It is also understood from this graph that the difference in viscosity between the high degree hydrocracking process residue and the other mineral oil plasticizers becomes remarkable, in particular, in the range of room temperature.

The plasticizer of the invention is a plasticizer which makes use of the nature of the high degree hydrocracking process residue that the residue is excellent in plasticity at high temperature and turns into a solid state at room temperature. That is, according to the plasticizer of the invention, the high degree hydrocracking process residue itself exhibits plasticity, additionally, other liquid plasticizer components are also taken therein by incorporating the high degree hydrocracking process residue into the plasticizer. As a result, the plasticizer can be prevented from being released, separated or eluted from the polymer.

In order to cause this solidifying effect to be expressed in the plasticizer, it is necessary that the plasticizer contains therein 20 to 100% by mass of the high degree hydrocracking process residue. It is also necessary that the plasticizer has a softening point of 30° C. or higher and a kinematic viscosity of 3000 mm²/s or less at 100° C. as a whole. The “softening point” referred to herein is a value obtained by measurement according to “Petroleum Asphalt Softening Point Test Method” in JIS K 2207. The “kinematic viscosity” is a value obtained by measurement according to “Determination of Kinematic Viscosity and Calculation of Viscosity Index from Kinematic Viscosity” in JIS K 2283. The softening point is preferably 90° C. or lower in light of actual working temperatures of polymer.

When the plasticizer of the invention includes a component other than the high degree hydrocracking process residue, the material may be any material that is usually used as a plasticizer for polymer, examples thereof including phthalic acid esters, adipic acid esters, fatty acid esters, and mineral oil plasticizers. A plasticizer made mainly of a mineral oil plasticizer is in particular preferred from the viewpoint of the compatibility with the high degree hydrocracking process residue.

The mineral oil plasticizer is a mixture which has a function as a plasticizer and is made mainly of hydrocarbons obtained by subjecting crude oil to normal pressure distillation, vacuum distillation, extraction or other treatments without undergoing any step based on chemical reaction (except hydrogenating reaction). Typically, the mineral oil plasticizer is classified by the major component into naphthenic, paraffinic, aromatic plasticizer, and a plasticizer of a mixture thereof. Examples of a commercially available product thereof include FLEXON 819 (a paraffinic plasticizer, manufactured by Exxon Mobil), AROMAX #3 (an aromatic plasticizer, manufactured by FUJI KOSAN CO., LTD), and SNH 220 (a purified naphthenic plasticizer, manufactured by SANKYO YUKA KOGYOU K.K.). Particularly preferred are aromatic mineral oil plasticizers, that is, solvent extracted oils which are each a component which is rich in aromatic hydrocarbon and is extracted from light, middle and heavy oils fractionized in a vacuum distillation tower or a vacuum distillation residue oil with a solvent in a solvent extraction step, which is one out of steps of purifying mineral oil lubricant; or solvent extracted oils which are each a mixture of two or more out of such extracted components from the viewpoint of the compatibility thereof with polymer.

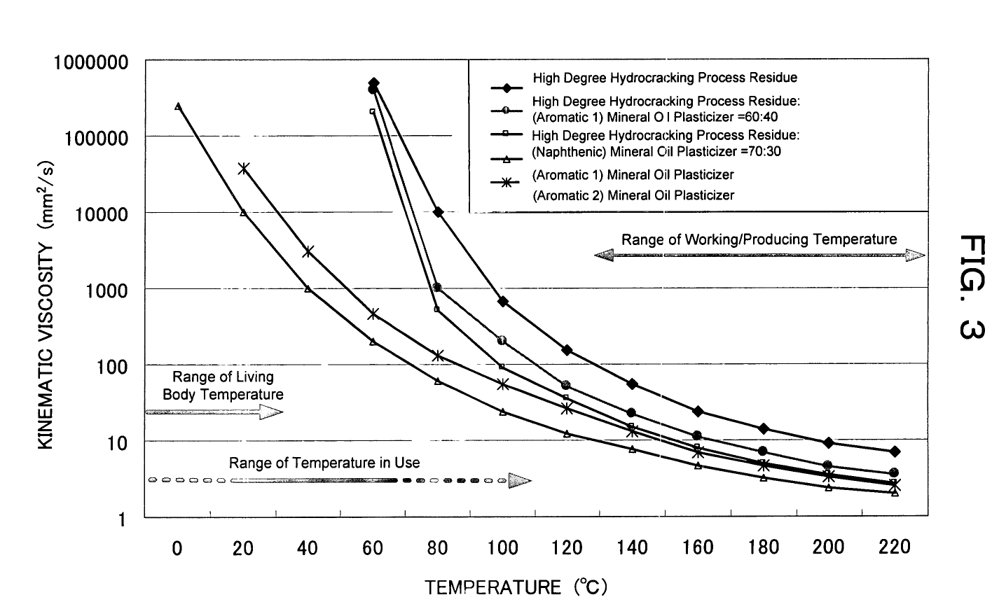

FIG. 3 is a graph showing relationship between kinematic viscosity and temperature about individual typical commercially available (aromatic) mineral oil plasticizers, and plasticizers which are mixtures thereof with a high degree hydrocracking process residue (the high degree hydrocracking process residue: the mineral oil plasticizer=60:40 (the aromatic plasticizer) and 70:30 (naphthenic plasticizer)). The mineral oil plasticizers and the mixture type plasticizers have substantially the same viscosity in a high temperature range, where polymer is processed or produced. From this graph also, it can be presumed that the plasticizing effect of the mixture type plasticizers is equivalent to that of the conventional mineral oil plasticizers in a high temperature state. However, it has been understood that as the temperature of the mixture type plasticizers falls, the viscosity thereof rises abruptly so that the plasticizers get into a solid state in the temperature range of polymer use and in the temperature range of living bodies. This demonstrates that: the mixture of a mineral oil plasticizer and a high degree hydrocracking process residue sufficiently exhibits plasticizer effects at high temperature, at which the effects of the plasticizer are required to be exhibited; and the mixture is a plasticizer which becomes a solid, when used or stored, so as not to cause harmful substances to be released, separated or eluted, that is, an excellent plasticizer in which performances and safety are compatible with each other.

In order to express the solidifying effect of the plasticizer on the basis of the mixing of a mineral oil plasticizer and a high degree hydrocracking process residue, the high degree hydrocracking process residue is added preferably in an amount of 20 to 400 parts by mass, more preferably in an amount of 30 to 200 parts by mass for safety to 100 parts by mass of the mineral oil plasticizer.

Examples of a partner polymer to which the plasticizer of the invention is added include: thermoplastic resins such as polystyrene, polyethylene, and polypropylene; rubbers such as natural rubber, butadiene rubber, styrene-butadiene rubber, isoprene rubber, chloroprene rubber, butyl rubber, ethylene-propylene rubber, nitrile rubber, and acrylic rubber; thermoplastic elastomers such as olefin elastomers (TPO), styrene-butadiene-styrene block copolymer (SBS), and styrene-isoprene-styrene block copolymer (SIS); and blended polymers thereof. The adding amount of the plasticizer of the invention, which is varied in accordance with the partner polymer to be added, is usually from 5 to 200 parts by mass, preferably from 10 to 100 parts by mass to 100 parts by mass of the polymer.

The plasticizer of the invention is used, left as it is under sever outdoor conditions, it is in particular useful as a process oil for a rubber composition for a tire, about which the safety of a plasticizer in particulate state by tire wear becomes a serious problem.

### EXAMPLES

### Example 1

### Effect of Solidifying a Mineral Oil Plasticizer by Action of a High Degree Hydrocracking Process Residue

A high degree hydrocracking process residue was added to a commercially available mineral oil plasticizer as an example, and then an experiment was made for demonstrating the effect of solidifying the mineral oil plasticizer by action of the high degree hydrocracking process residue.

200 cc of a high degree hydrocracking process residue and 200 cc of AROMAX #3 (an aromatic mineral oil, manufactured by FUJI KOSAN CO., LTD) were stirred at 200° C. for 10 minutes. This was allowed to stand still for 6 hours, and then the following operation was repeated for one month: an operation that the mixture was allowed to stand still in a hot water bath of 100° C. temperature for 1 hour and was then allowed to stand still at room temperature for 23 hours”. After the one month, whether or not phase separation was caused was examined by observing the external appearance of the resultant with the eyes or palpating the resultant (a plasticizer 1A).

Similarly, experiments and evaluations were made in the same way as in the above-mentioned example except that the mineral oil plasticizer was changed to FLEXON 819 (a high-viscosity paraffinic mineral oil, manufactured by Exxon Mobil, bright stock) or SNH 220 (a purified naphthenic mineral oil, manufactured by SANKYO YUKA KOGYO K.K.), respectively (plasticizers 1B and 1C). The results are shown in Table 1.

TABLE 1

| | Plasticizer | Plasticizer | Plasticizer |
|---|---|---|---|
| | 1A | 1B | 1C |
| Mineral oil plasticizer | AROMAX#3 | FLEXON819 | SNH220 |
| Phase separation | None | None | None |
| (Observation with the eyes) | | | |
| Phase separation (palpation) | None | None | None |

As is apparent from Table 1, the phase separation was not observed in any one of the mineral oil plasticizer in a liquid state after the passage of the one month. Thus the plasticizer was completely taken in the high degree hydrocracking process residue.

### Example 2

### Evaluation of Rubber Compositions (for Tires)

Plasticizers of the invention were used to produce rubber compositions so as to have compositions in Table 2. Performance tests thereof were made. As the plasticizers, plasticizers 2A to 2E described in Table 3 were used. In Table 3, “FLEXON 848” is a paraffinic mineral oil plasticizer manufactured by Exxon Mobil. The plasticizers 2A and 2B were obtained by heating a high degree hydrocracking process residue and AROMAX #3 and FLEXON 848 respectively, to 200° C. and mixing them. In a Banbury mixer (into which a roll S having a diameter of 10 inches was incorporated), raw materials were mixed to have a composition described in Table 2, and then the mixture is extruded, molded and vulcanized (at 160° C. for 20 minutes) under the normal procedures to prepare five test pieces, in the form of a dumbbell-form (No. 3 model) described in JIS K 6521, in which the plasticizers were different from each other.

TABLE 2

| | Blended amount (Parts by mass) |
|---|---|
| S-SBR | 100 |
| Carbon black | 85 |
| Plasticizer | 50 |
| Others* | 5 |

*A vulcanizing agent, a vulcanization promoter, an anti-aging agent and so on

About the resultant test pieces, the workabilities (short-term bleeding property, kneading-stage workability, and vulcanization property) at the stage of producing rubber compositions, and rubber properties (tensile strength, elongation, fuel consumption, gripping property, and abrasion resistance) of the rubber compositions were evaluated using four ranks for which the plasticizer 2C was used as a standard. The ranks for the evaluation were as follows. The results are shown in Table 3.

TABLE 3

| | | Plasticizer 2A | Plasticizer 2B | Plasticizer 2C | Plasticizer 2D | Plasticizer 2E |
|---|---|---|---|---|---|---|
| | Plasticizer | HOB* 50% | HOB* 50% | AROMAX#3 | FLEXON819 | MES** |
| | composition | AROMAX#3 50% | FLEXON848 50% | 100% | 100% | 100% |
| Workabilities | Short-term bleeding | ◯ | ◯ | ◯ | X | Δ |
| | property | | | | | |
| | Kneading workability | ◯ | ◯ | ◯ | — | [symbol] |
| | Vulcanizing property | ◯ | ◯ | ◯ | — | ◯ |
| Rubber | Tensile strength | [symbol] | ◯ | ◯ | — | Δ |
| physical | Elongation | ◯ | ◯ | ◯ | — | Δ |
| properties | Fuel consumption*** | [symbol] | ◯ | ◯ | — | [symbol] |
| | Gripping property*** | [symbol] | Δ | ◯ | — | X |
| | Abrasion resistance**** | [symbol] | Δ | ◯ | — | ◯ |
| Notes | | Example | Example | Comparative | Comparative | Comparative |
| | | | | Example | Example***** | Example |

*HOB: High degree hydrocracking process residue
**MES manufactured by Exxon Mobil, a paraffinic mineral oil plasticizer, which is a product obtained by conducting hydrogenation and extraction minutely so as to have a 3% or less of PCA.
***The gripping property was evaluated on the basis of values at 0° C. and 23° C. in a Luebke impact anti-resilience test stipulated in JIS K 6255 and the fuel consumption was evaluated on the basis of values at 50° C. and 70° C. in the same test.
****The abrasion resistance was evaluated based on a pico abrasion test.
*****During the test piece production, bleeding was largely caused so that no evaluation was made. [symbol]
: The plasticizer was excellent.
◯: The plasticizer had performances equivalent to those of the plasticizer 2C.
Δ: The plasticizer was able to be used but has a slightly poor perfomance.
X: The plasticizer had very poor performances and was unable to be practically used.

It is understood from the results in Table 3 that rubber compositions each using the plasticizer of the invention, which had the high degree hydrocracking process residue, had performances suitable for practical use of a tire. Furthermore, about the four test pieces produced as described above except the plasticizer 2D, light from a xenon arc lamp was radiated thereto at 50° C. (from 300 nm to 800 nm, 550 W) so as to make a forcibly-deteriorating test until the rubber surface of the test piece using the plasticizer 2C was deteriorated so that the plasticizer was bled out into a liquid form. As a result, in the test piece using the plasticizer 2E, the bleeding-out of the plasticizer was observed on the surface of the rubber in the same manner as in that using the plasticizer 2C, and further the test piece was sticky to the touch. On the other hand, in the test pieces using the plasticizers 2A and 2B, which were deteriorated to the same degree, the bleeding-out of the plasticizers was not observed at all from their external appearances. When the test pieces were palpated, the pieces were not sticky to the touch. This is thought to be based on the following effect: since the plasticizers 2A and 2B were each subjected to mixing at a high temperature (200° C.), the high degree hydrocracking process residue and AROMAX #3 or FLEXON 848 were integrated with each other so that the transition point of the glass transition temperature of the mixed plasticizer drew a gentle slope, thereby giving stable physical properties to a tire.

### Example 3

### Evaluation for Rubber Compositions for Racing Tires

In the same way as in Example 2, raw materials described in Table 4 were used to produce dumbbell-shaped test pieces and make performance tests thereof. As the plasticizers, plasticizers 3A to 3C described in Table 5 were used.

TABLE 4

| | Blended amount (parts by mass) |
|---|---|
| Cis-form high molecular weight SBR | 100 |
| Carbon black | 100 |
| Plasticizer | 20* |
| Others** | 5 |

*25 parts were used for the plasticizer 3B.
**A vulcanizing agent, a vulcanization promoter, an anti-aging agent and so on

About the resultant test pieces, the workabilities (extrudability, vulcanization property, and rubber elasticity) at the stage of producing rubber compositions, and rubber properties (tensile strength, abrasion resistance, and braking property) of the rubber compositions were evaluated by using four ranks for which the plasticizer 3C was used as a standard. The ranks for the evaluation were as follows. The results are shown in Table 5.

TABLE 5

| | | Plasticizer 3A | Plasticizer 3B | |
|---|---|---|---|---|
| | Plasticizer | HOB* 50% | HOB* 70% | Plasticizer 3C |
| | composition | AROMAX#3 50% | AROMAX#3 30% | AROMAX#3 100% |
| Workabilities | Extrudability | [symbol] | [symbol] | ◯ |
| | Vulcanizing property | ◯ | ◯ | ◯ |
| | Rubber elasticity | [symbol] | [symbol] | ◯ |
| Rubber physical | Tensile strength | [symbol] | [symbol] | ◯ |
| properties | Abrasion resistance** | [symbol] | [symbol] | ◯ |
| | Braking property*** | [symbol] | [symbol] | ◯ |
| Notes | | Example | Example | Comparative Example |

*HOB: High degree hydrocracking process residue
**It was evaluated according to a pico abrasion test.
***It was evaluated on the basis of tanδ (at 0° C. and 50° C.). [symbol]
: The plasticizer was excellent.
◯: The plasticizer had performances equivalent to those of the plasticizer 3C.
Δ: The plasticizer was able to be used but has a slightly poor performance.
X: The plasticizer had very poor performances and was unable to be practically used.

It is understood from the results in Table 5 that the rubber compositions each using the plasticizer of the invention, having the high degree hydrocracking process residue, had performances suitable for practical use as racing tires. Furthermore, the test pieces were subjected to a forcibly-deteriorating test in which the 3C was used as a standard in the same way as in Example 2. As a result, on the surfaces of the test pieces each using the plasticizer of the example (the plasticizer 3A or 3B), the plasticizer was not sticky at all from the external appearance and the palpation thereof. This is thought to be based on the following effect: since the plasticizers 3A and 3B were each subjected to mixing at a high temperature (200° C.), the high degree hydrocracking process residue and AROMAX #3 were integrated with each other so that the transition point of the glass transition temperature of the plasticizer of the mixture drew a gentle slope, thereby giving stable physical properties to a tire.

The above has described the present invention associated with the most practical and preferred embodiments thereof. However, the invention is not limited to the embodiments disclosed in the specification. Thus, the invention can be appropriately varied as long as the variation is not contrary to the subject substance and conception of the invention which can be read out from the claims and the whole contents of the specification. It should be understood that plasticizers, polymer compositions, rubber compositions and tires with such an alternation are included in the technical scope of the invention.

### INDUSTRIAL APPLICABILITY

The plasticizer, the polymer composition, the rubber composition and the tire according to the invention are excellent in safety, productivity and economical efficiency. Thus, the invention has a significantly high industrial applicability.

### BRIEF DESCRIPTION OF THE DRAWINGS

[FIG. 1] It is a graph showing relationship between kinematic viscosity and temperature about asphalts and high degree hydrocracking process residues therefrom.

[FIG. 2] It is a graph showing relationship between kinematic viscosity and temperature about a high degree hydrocracking process residue and typical commercially available mineral oil plasticizers.

[FIG. 3] It is a graph showing relationship between kinematic viscosity and temperature about individual aromatic mineral oil plasticizers and plasticizers which are mixtures thereof with a high degree hydrocracking process residue.

1. A plasticizer, comprising 20 to 100% by mass of a high degree hydrocracking process residue, and having a softening point of 30° C. or higher and a kinematic viscosity of 3000 mm²/s or less at 100° C.

2. A plasticizer wherein 20 to 400 parts by mass of a high degree hydrocracking process residue are added to 100 parts by mass of a mineral oil plasticizer.

3. The plasticizer according to claim 2, wherein the mineral oil plasticizer is a solvent extracted oil.

4. A polymer composition to which the plasticizer according to claim 1 is added.

5. A rubber composition to which the plasticizer according to claim 1 is added.

6. A tire wherein the rubber composition according to claim 5 is processed.
